(19) United States
(12) Patent Application Publication
(10) Pub. No.: US 2026/0254578 A1
(43) Pub. Date: Aug. 27, 2026

(54) SIGNALING COMMUNICATION DEVICE TRANSMISSION TIMING ERROR GROUP ASSOCIATION FOR UPLINK TIME DIFFERENCE OF ARRIVAL

(71) Applicant: Telefonaktiebolaget LM Ericsson (publ), Stockholm (SE)

(72) Inventors: Xiaolin JIANG, Linköping (SE); Ritesh SHREEVASTAV, Upplands Väsby (SE); Yazid LYAZIDI, London (GB); Siva MURUGANATHAN, Stittsville (CA); Florent MUNIER, Västra Frölunda (SE)

(21) Appl. No.: 18/726,424

(22) PCT Filed: Dec. 30, 2022
(86) PCT No.: PCT/SE2022/051256

§ 371 Date: Jul. 3, 2024

Related U.S. Application Data
(60) Provisional application No. 63/297,183, filed on Jan. 6, 2022.

(51) Int. Cl. H04L 5/00

(52) U.S. Cl. CPC H04L 5/0048

(57) ABSTRACT

A communication device of a communications network can receive a request message from a network node of the communications network. The request message can request an indication of reference signal (“RS”) resources used by the communication device to communicate with the network node and an indication of a timing error group (“TEG”) identifier (“ID”) associated with the RS resources. The communication device can transmit the indication of the RS resources and the indication of the TEG ID to the network node.

### TECHNICAL FIELD

The present disclosure is related to wireless communication systems and more particularly to signaling communication device transmission timing error group association for uplink time difference of arrival.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

FIG. 2 illustrates an example of a NR positioning architecture. Since Release-15 of the 3^{rd} Generation Partnership Project (“3GPP”) and the introduction of NR, the long term evolution positioning protocol (“LPP”), which is a point-to-point communication protocol between a location management function (“LMF”) and a target device, has been agreed to be reused for UE positioning in both NR and LTE.

The logical node called the LMF can be in the core network and can be the main server responsible for computing the UE position, based on the NR, E-UTRA, or both radio access technologies (“RATs”) specific positioning methods in a hybrid way. NR Positioning Protocol A (“NRPPa”) is the communication protocol between a next generation radio access network (“NG-RAN”) and LMF.

In Release 16, new and enhanced positioning methods have been defined in NR for helping computing UE positioning, such as: NR enhanced cell identifier (“E-CID”); Multi-Round Trip Time (“RTT”) Positioning; Downlink Angle-of-Departure (“DL-AoD”); Downlink Time Difference of Arrival (“DL-TDOA”); Uplink Time Difference of Arrival (“UL-TDOA”); Uplink Angle of Arrival (“UL-AoA”), including the Azimuth of Arrival (“A-AoA”) and the Zenith of Arrival (“Z-AoA”).

### SUMMARY

There currently exist certain challenges. To mitigate UE Tx timing errors for UL TDOA, the UE sends the association information of UL SRS resources for positioning with Tx TEGs to the serving gNB, and the serving gNB should forward the association information provided by the UE to the LMF. However, the signaling of the association information adds load to the network. The signaling mechanism to send association information of UL SRS resources for positioning with Tx TEGs should be well designed/optimized. One problem includes determining how to define the information elements (IE) to carry the association information from UE to its serving gNB and further to LMF for UL TDOA. A second problem is that after the UL SRS is configured by the serving gNB for the UE, it is unclear what the mechanism is for the UE to send the initial and updated association information to serving gNB, and the transmission mechanism between serving gNB and LMF. A third problem is that it is unclear if a neighbour gNBs has knowledge of the association information of the UL SRS resources for positioning with Tx TEGs or not. If the neighbour gNBs do have knowledge of the association information, it is unclear who (LMF or serving gNB) this information should be forwarded to, and how the association information should be forwarded.

Certain aspects of the disclosure and their embodiments may provide solutions to these or other challenges. Some embodiments herein provide a mechanism that the UE initially provides TEG association to the serving gNB for UL-TDOA for all (or subset) of configured SRS resources, and then for subsequent association reporting, the UE only sends the delta association for the SRS resources that change TEG association.

Additional or alternative embodiments herein provide a mechanism that the gNB uses to forward the TEG association periodically, or on a need basis, or upon request to the LMF.

Additional or alternative embodiments herein provide a mechanism for the gNB to receive the TEG association and measure multiple UL SRS associated with different UE Tx TEGs. This mechanism covers also the case of split gNB architecture with gNB-CU and gNB-DU.

Additional or alternative embodiments herein provide a mechanism that the LMF uses to receive the TEG association and utilize the info to instruct neighbour gNBs to measure UL-SRS associated with different UE Tx TEGs.

In some examples, a procedure is provided to configure the IEs to carry the association information of the UL SRS resources for positioning with Tx TEGs in RRC, MAC-CE, F1 and NRPPa.

In additional or alternative examples, a procedure is provided to configure the mechanism of how UE to send the initial and updated association information to serving gNB, and the transmission mechanism between serving gNB and LMF for UL-TDOA

In additional or alternative examples, a procedure is provided to configure the LMF request to use the association information and instruct neighbour gNBs which UL SRS to measure to achieve high positioning accuracy.

In additional or alternative examples, a procedure is provided to configure the LMF to inform Reception Points/gNBs of the TEG association and asks the listening RPs/gNBs to prioritize listening to certain TEG over other.

FIG. 8 illustrates an example of operations according to some embodiments herein. A gNB neighbor informs a gNB serving of latency requirements for determining positioning of a UE. The gNB serving transmits instructions to the UE to configure SRS and requests SRS resource and TEG ID association. In response, the UE provides the SRS resource and TEG ID association to the gNB serving. The gNB serving then provides the SRS resource and TEG ID association to the gNB neighbor. A LMF prioritizes SRS resource measurements for certain TEG IDs and provides prioritized SRS resource management information to the gNB neighbor. Using the SRS resource and TEG ID association as well as the prioritized SRS resource measurement information, the gNB neighbor provides measurement results to the LMF. The LMF then estimates the positioning.

In some embodiments, the steps of ‘Prioritize SRS Resource measurements for certain TEG IDs’, ‘Provide Prioritized SRS Resource measurement Information’, and ‘Provide measurement Result’ may be optional in some embodiments.

In additional or alternative embodiments, a LMF optionally provides the delay budget (latency) requirements to serving gNB and serving gNB configures the UL SRS and requests the TEG association (piggybacks the requirements of TEG information in SRS configuration). Further, serving gNB instructs the UE whether UE shall use RRC or MAC CE based reporting. If no instruction is provided, a default method is selected by the UE.

According to some embodiments, a method of operating a communication device of a communications network is provided. The method includes receiving a request message from a network node of the communications network. The request message requests an indication of reference signal (“RS”) resources used by the communication device to communicate with the network node and an indication of a timing error group (“TEG”) identifier (“ID”) associated with the RS resources. The method further includes transmitting the indication of the RS resources and the indication of the TEG ID to the network node.

According to other embodiments, a method of operating a first network node of a communications network is provided. The method includes determining a timing error group (“TEG”) identifier (“ID”) associated with reference signal (“RS”) resources used by a communication device to communicate with the first network node. The method further includes transmitting a message to a second network node configured to provide a location management function (“LMF”). The message includes the indication of the RS resources and the indication of the TEG ID.

According to other embodiments, a method of operating a first network node of a communications network is provided. The first network node is configured to provide a location management function (“LMF”). The method includes receiving a message from a second network node. The message includes: an indication of reference signal (“RS”) resources used for communication between the second network node and a communication device; an indication of a first timing error group (“TEG”) identifier (“ID”) associated with the RS resources and the communication device; and an indication of second TEG ID associated with the RS resources and the second network node. The method further includes estimating a position of the communication device based on the message.

According to other embodiments, a communication device, a network node, a computer program, and/or a computer program product are provided to perform one of the above methods.

Certain embodiments may provide one or more of the following technical advantages. Some embodiments allow a network (“NW”) to obtain the updates of TEG association swiftly/dynamically and use this info to improve the relative time of arrival (“RTOA”) measurements. Additional or alternative embodiments provide options to provide only delta TEG association which reduces signaling overhead. Additional or alternative embodiments reduce latency as listening gNBs/RPs only measure a subset of prioritized SRS resources rather than complete resources.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of new radio (“NR”) positioning architecture;

FIG. 3 is a signal flow diagram illustrating an example of an uplink (“UL”)-time difference of arrival (“TDOA”) operation;

FIG. 4 is a diagram illustrating an example of transmission (“TX”) timing errors that do not cancel when forming 5G network node (“gNB”) TDOA measurements;

FIG. 5 is a schematic diagram illustrating an example of a communication device (e.g., user equipment (“UE”)) communicating with different transmission and reception points (“TRPs”) using different antenna panels;

FIG. 6 is a diagram illustrating an example of positioning error based on timing errors;

FIG. 7 is a schematic diagram illustrating an example of when timing errors do/do not cancel out;

FIG. 8 is a signal flow diagram illustrating an example of operations for signaling UE TX timing error group (“TEG”) association for UL-TDOA in accordance with some embodiments;

FIG. 9 is a table illustrating an example of initial UE TX TEG association to sounding reference signal (“SRS”) resources reported by the UE to the serving gNB in accordance with some embodiments;

FIGS. 10-11 are tables illustrating examples of a delta association report in accordance with some embodiments;

FIG. 12 is a table illustrating an example of a F1 positioning information update message in accordance with some embodiments;

FIG. 13 is a table illustrating an example of an information element (“IE”) that includes the TEG association in accordance with some embodiments;

FIG. 14 is a table illustrating an example of a NR Positioning Protocol A (“NRPPa”) positioning information update message in accordance with some embodiments;

FIG. 15 is a table illustrating an example of an IE that includes the TEG association in accordance with some embodiments;

FIG. 16 is a table illustrating an example of an IE that indicates a spatial relation for transmission of UL SRS by a UE in accordance with some embodiments;

FIG. 17 is a table illustrating an example of an measurement request message transmitted by the LMF to request a NG-RAN node configure a positioning measurement in accordance with some embodiments;

FIG. 18 is a table illustrating an example of a ifReportCharacteristicPeriodic IE in accordance with some embodiments;

FIG. 19 is a table illustrating an example of potential configurations associated with a measurement request message in accordance with some embodiments;

FIGS. 20-21 are diagrams illustrating examples of UEAssistanceInformation messages in accordance with some embodiments;

FIG. 22 is a diagram illustrating an example of a ASN.1 code for UE TX association reporting in accordance with some embodiments;

FIG. 23 is a diagram illustrating an example of a flag for indicating whether the UE sends full or only delta configuration in accordance with some embodiments;

FIG. 24 is a schematic diagram illustrating an example of a media access control (“MAC”) control element (“CE”) representing either full configuration or delta configuration in accordance with some embodiments;

FIG. 25 is a flow chart illustrating an example of operation performed by a communication device in accordance with some embodiments;

FIG. 26 is a flow chart illustrating an example of operation performed by a network node in accordance with some embodiments;

FIG. 27 is a flow chart illustrating an example of operation performed by a network node configured to provide a location management function, LMF, in accordance with some embodiments;

FIG. 28 is a block diagram of a communication system in accordance with some embodiments;

FIG. 29 is a block diagram of a user equipment in accordance with some embodiments

FIG. 30 is a block diagram of a network node in accordance with some embodiments;

FIG. 31 is a block diagram of a host computer communicating with a user equipment in accordance with some embodiments;

FIG. 32 is a block diagram of a virtualization environment in accordance with some embodiments; and

FIG. 33 is a block diagram of a host computer communicating via a base station with a user equipment over a partially wireless connection in accordance with some embodiments in accordance with some embodiments.

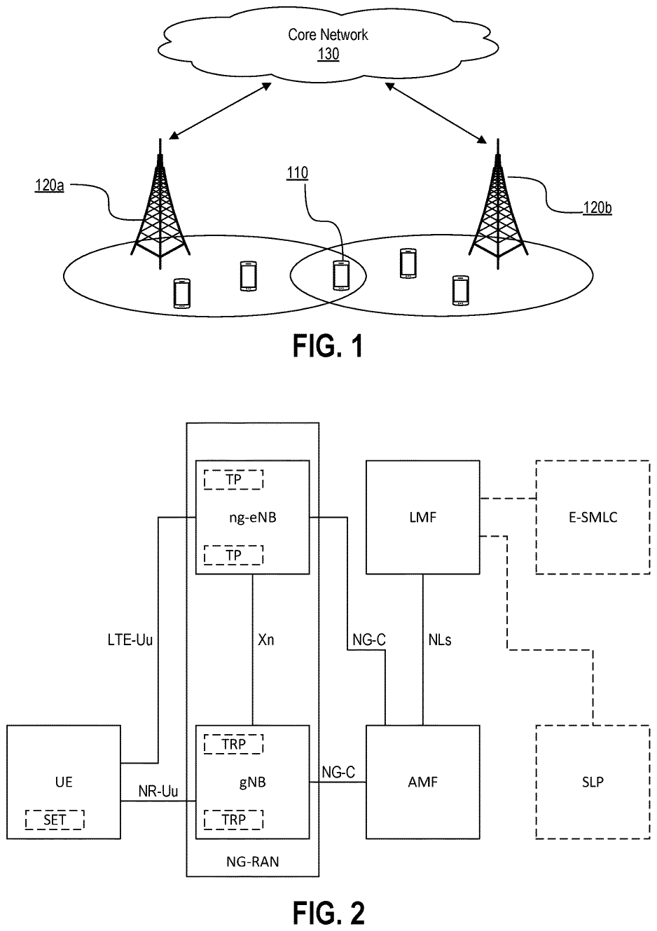

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

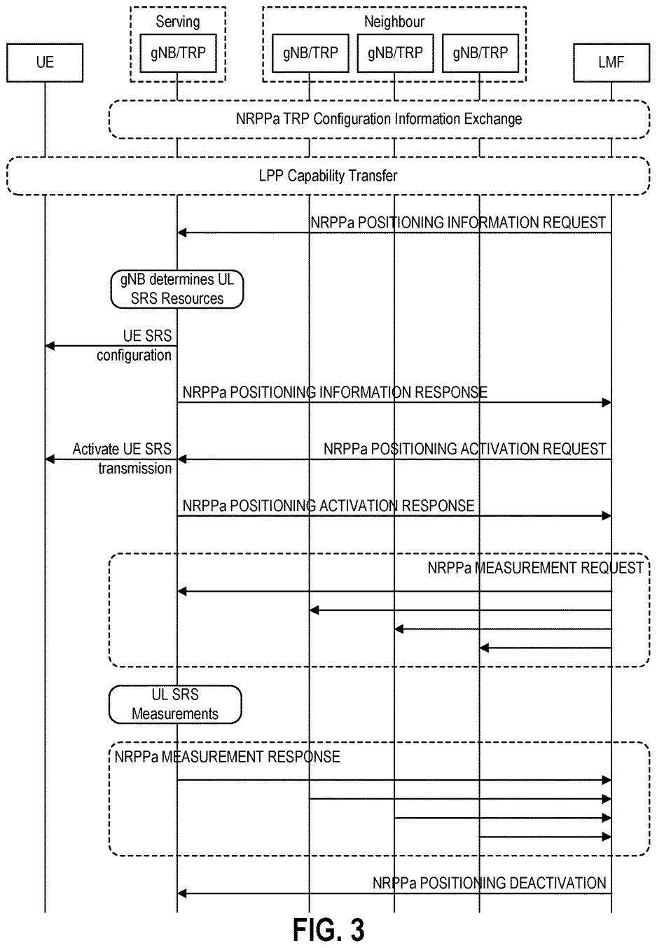

FIG. 3 illustrates an example of a signaling exchange for uplink (“UL”)-time difference of arrival (“TDOA”) positioning (which may also be applicable for UL-angle of arrival (“AOA”)).

In Rel-16, a Multi-RTT positioning operation was specified as part of this UE performs UE receive (“Rx”)-transmit (“Tx”) measurements.

In Release 17, the accuracy enhancements for time-based methods (multi-RTT, DL TDOA, UL TDOA) have been proposed to mitigate timing errors, which resulted in the introduction of the timing error group (“TEG)” concept. The principle stems from the observation that signals transmitted or received on different beams may be carried over different RF chains or different antenna panels. Even after calibration in the UE/transmit and receive point (“TRP”) implementation, there will always be a residual timing error in transmission and reception timing between signals transmitted over these different radio frequency (“RF”) chains/antenna panels.

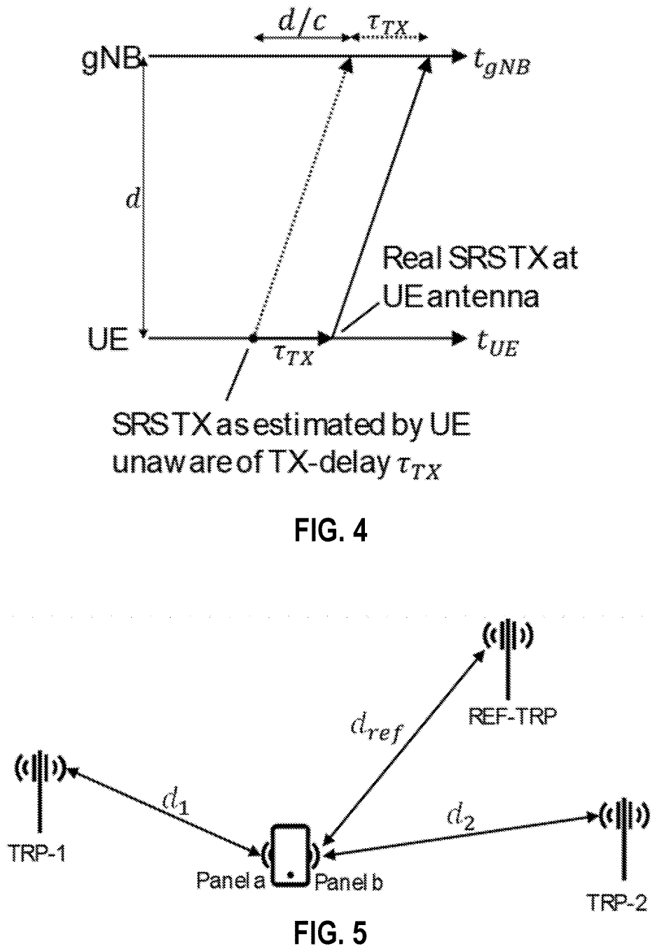

As a consequence of such residual timing errors (referred to as timing errors henceforth), the UE may not know exactly when a signal such as the SRS is transmitted from the UE-antenna as demonstrated in FIG. 4. If the UE has only one antenna panel, this TX (transmit) timing error will cancel when TDOA measurements are formed from gNB time of arrival (TOA) measurements.

FIG. 4 illustrates that, as a consequence of timing errors, the UE may not know exactly when a signal such as the sounding reference signal (“SRS”) is transmitted from the UE-antenna, resulting in an unknown TX-delay, τ_{TX}. Note that τ_{TX} is the remaining error after any compensation performed by the UE for known delays and that τ_{TX} can be positive or negative.

When the UE has multiple antenna panels, the TX timing error can be different for the different UE antenna panels and as a consequence TX timing errors don't always cancel when forming gNB TDOA measurements as illustrated in FIG. 5. When the same UE antenna panel is utilized both for the target TRP and for the reference TRP, the TX timing errors cancel when the reference signal time difference (“RSTD”) is formed (e.g., RSTD₂=(d₂-d_{ref})/c). However, when different UE antenna panels are utilized for the target TRP and for the reference TRP the TX timing errors don't cancel when the RSTD is formed (e.g., RSTD₁=(d₁−d_{ref})/ c+τ_{TX, a}−τ_{TX, b}).

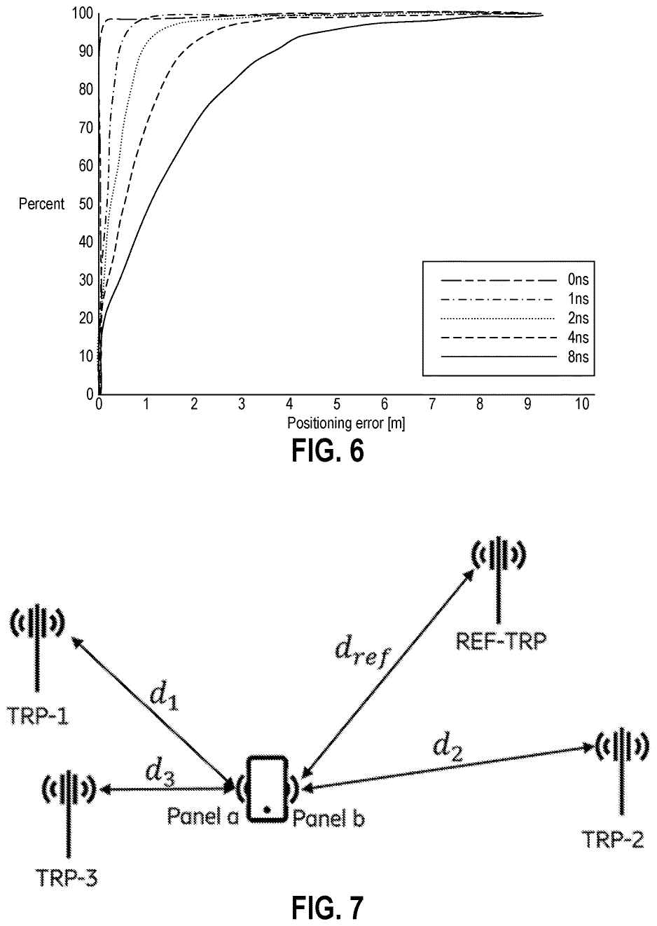

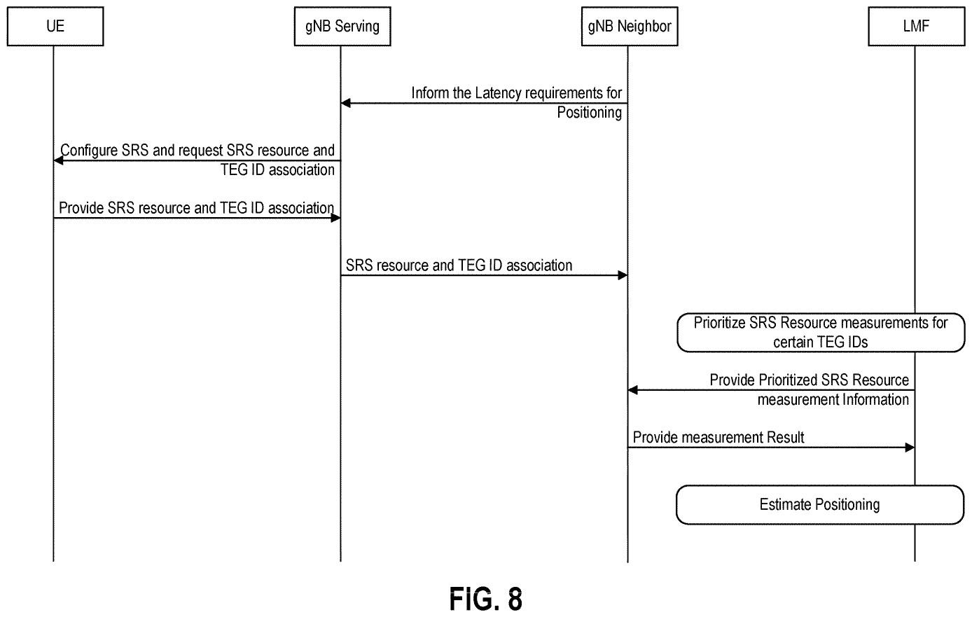

As are results of the Tx timing error differences (i.e., when the Tx timing errors do not cancel as in the case of RSTD₁ in FIG. 5), the accuracy for UL TDOA positioning is reduced as shown by simulations for the InF-SH scenario (3GPP TR 38.857V 17.0.0 ) in FIG. 6. UL TDOA positioning accuracy for two UE antenna panels with a random TX timing error with a normal distribution with std σ=0, 1, 2, 4 and 8 ns truncated at 26 in the InF-SH scenario. A 2-symbol comb-2 UL SRS was used at 28 GHz carrier, 120 kHz subcarrier spacing and 400 MHz bandwidth. Positioning accuracy is severely reduced for large TX timing errors.

However, if one reference TRP is used for each UE antenna panel when forming RSTD measurements, then the TX timing errors do cancel as illustrated in FIG. 7. In the figure, TRP-1 is added as reference TRP for antenna panel a while the standard REF-TRP is maintained as reference TRP for antenna panel b.

FIG. 7 illustrates that when forming RSTD measurements in the normal way utilizing one reference TRP, the TX timing errors don't generally cancel (e.g., RSTD₁=(d₁−d_{ref})/c+τ_{RX,a}−τ_{RX,b} and RSTD₃=(d₃-d_{ref})/c+T_{RX,a}−T_{RX,b}). However, if one reference TRP is used for each antenna panel when forming RSTD measurements then the TX timing errors do cancel. In the figure, TRP-1 is added as reference TRP for antenna panel a while the standard REF-TRP is maintained as reference TRP for antenna panel b, resulting in the two TX timing error free RSTD measurements (e.g., RSTD₂ =(d₂−d_{ref})/c) and RSTD₃₋₁=RSTD₃-RSTD₁ =(d₃−d₁)/c.

To make it possible for LMF to know which measurements can be combined such that the associated TX timing errors cancel, TEG concept is introduced in 3GPP NR Release 17. When the LMF knows which measurements can be grouped using the TEG concept, the TX timing errors can be mitigated and the positioning performance can be greatly improved. Different types of TEGs at both the UE and TRP have been introduced in NR Release 17. These include the following: UE Tx ‘timing error group’ (“UE Tx TEG”); TRP Tx ‘timing error group’ (“TRP Tx TEG”); UE Rx ‘timing error group’ (“UE Rx TEG”); and TRP Rx ‘timing error group’(“TRP Rx TEG”).

A UE Tx TEG is associated with the transmissions of one or more UL SRS resources for the positioning purpose, which have the Tx timing errors within a certain margin.

A TRP Tx TEG is associated with the transmissions of one or more DL PRS resources, which have the Tx timing errors within a certain margin.

A UE Rx TEG is associated with one or more DL measurements, which have the Rx timing errors within a certain margin.

A TRP Rx TEG is associated with one or more UL measurements, which have the Rx timing errors within a margin.

In NR Rel-17, TEGs can be used to mitigate the impact of UE TX timing errors for on UL TDOA/Multi-RTT positioning. In order to achieve this, the UE needs to report the association between SRS (transmitted in SRS resources) and UE Tx TEGs (i.e., associated UE TX TEG IDs).

Defining mechanism for UE to provide Tx TEG to SRS association to serving gNB is described below.

In some embodiments, a UE initially provides UE Tx TEG association to the serving gNB for all (or subset) of configured SRS resources, and then for subsequent association reporting, the UE only sends the delta association for the SRS resources that change TEG association.

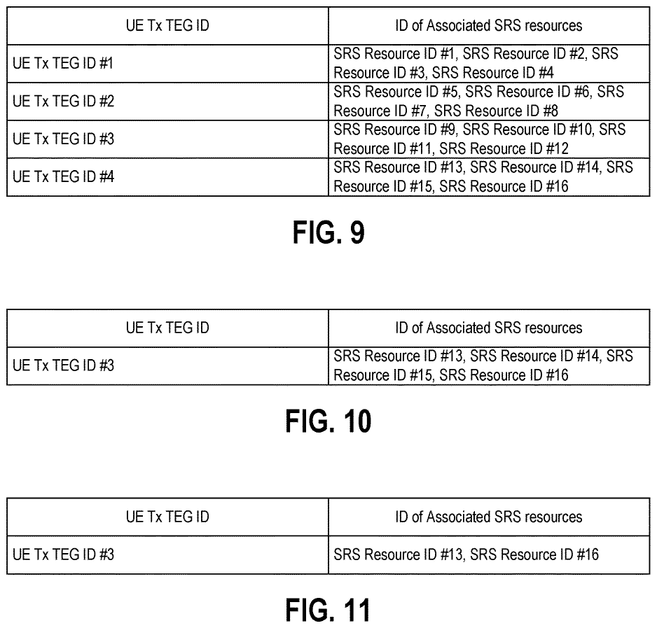

Considering an example where there are 4 UE Tx TEGs and there are 16 SRS resources configured to the UE for the purpose of positioning. FIG. 9 illustrates an example of the initial UE Tx TEG association to SRS resources reported by the UE to the serving gNB.

Now, before the next association reporting, the UE Tx TEG ID associated with certain SRS resources change while the UE Tx TEG ID associated with the other SRS resources remain unchanged. These changes may be due to, for example, a UE rotating which results in a new UE antenna panel (i.e., UE Tx TEG ID) becoming more suitable for transmitting an SRS to a given TRP. Another reason could be that a UE turning off a particular UE antenna panel (i.e., UE Tx TEG ID) for power saving purposes, in which case that particular UE antenna panel (i.e., UE Tx TEG ID) becoming unavailable for SRS transmission. It can be assumed, for instance, that the UE turns of the UE antenna panel corresponding to UE Tx TEG ID #4. Then, SRSs to be transmitted from SRS resources with IDs #13, #14, #15, and #16 cannot be associated with UE Tx ID #4 in the next association reporting (i.e., since the UE antenna panel associated with UE Tx TEG ID #4 is unavailable for SRS transmission). In this case, a UE may transmit SRSs in one or more of SRS resources with IDs #13, #14, #15, and #16 using another UE antenna panel associated with UE Tx TEG ID #3. In one embodiment, the UE may report a delta association report to the serving gNB where only the UE Tx TEG ID association for SRSs whose UE Tx TEG ID has changed relative to the previous association reporting instance is reported. In the above example, only the SRSs in SRS resources with IDs #13, #14, #15, and #16 have a change in the associated UE Tx TEG ID from #4 to #3. FIG. 10 illustrates an example of the delta association report.

In one example embodiment, when the serving gNB receives the delta association report from the UE, the serving gNB assumes that the UE TX TEG ID association of the SRSs transmitted in the SRS resources with IDs that are not included in the delta association report are unchanged (e.g., using the above example, the serving gNB assumes that the UE Tx TEG IDs of SRSs with IDs #1- #12 are unchanged from the previous association reporting instance).

In another example, the UE may only transmit SRSs in a subset of SRS resources with IDs #13, #14, #15, and #16. Assume that the UE transmits SRSs in SRS resources with IDs #13 and #16, and does not transmit any SRSs in SRS resources with IDs #14 and #15.

In the above example, only the SRSs in SRS resources with IDs #13, #14, #15, and #16 have a change in the associated UE Tx TEG ID from #4 to #3. FIG. 11 illustrates an example of the delta association report (note that SRS Resource IDs #14 and #15 are not included as part of the delta association report in this example).

Even though only the UE Tx TEG IDs and associated SRS Resource IDs are shown in the example association and delta association reports above, in some other embodiments, the one or more SRS resource set IDs of the associated SRS resource IDs (i.e., some SRS resource IDs may correspond to one SRS resource set while some other SRS resource IDs correspond to another SRS resource set) may also be included in the association and delta association reports.

In some embodiments, UE may inform the initial UE TX TEG association to SRSs using an RRC message, and convey the delta association report using either RRC or MAC Control element message to the serving gNB.

Defining mechanism for serving gNB-DU to forward TEG association to serving gNB-CU is described below.

In some embodiments, the serving gNB-DU sends the UE TX TEG association information to the serving gNB-CU every time it receives a periodic update from UE over a RRC message or a MAC-CE message. The UE TX TEG association information sent by the serving gNB-DU to the serving gNB-CU may include one or more SRS resource set IDs and one or more SRS resource IDs associated with a UE TX TEG ID. For example, an association information may include the following information: [UE Tx TEG ID #1, SRS resource set ID #1, SRS resource IDs #1, #2, #3], [UE Tx TEG ID #2, SRS resource set ID #1, SRS resource IDs #4, #5], [UE Tx TEG ID #3, SRS resource set ID #2, SRS resource IDs #1, #2].

In another embodiment, the serving gNB-DU may report a delta association report to the serving gNB-CU where only the UE Tx TEG ID association for SRSs whose UE Tx TEG ID has changed relative to the previous association reporting instance from serving gNB-DU to the serving gNB-CU is reported. For example, assume that the serving gNB-DU sends the association reporting in one instance to the serving gNB-DU as shown in the example above.

Before the next association reporting instance, the serving gNB-DU receives an update from the UE where the UE Tx TEG ID associated with SRS resource IDs #1 and #2 in SRS resource set ID #2 has changed. Then, in the next association reporting instance, serving gNB-DU only reports the UE Tx TEG ID association for SRS resource IDs #1 and #2 in SRS resource set ID #2 to the serving gNB-CU in a delta association report.

In one embodiment, the gNB-DU sends the indication of the UE TEG association to the gNB-CU over F1. Such indication can be signaled over a new F1 UE associated signaling procedure or by enhancing existing positioning procedure in F1AP.

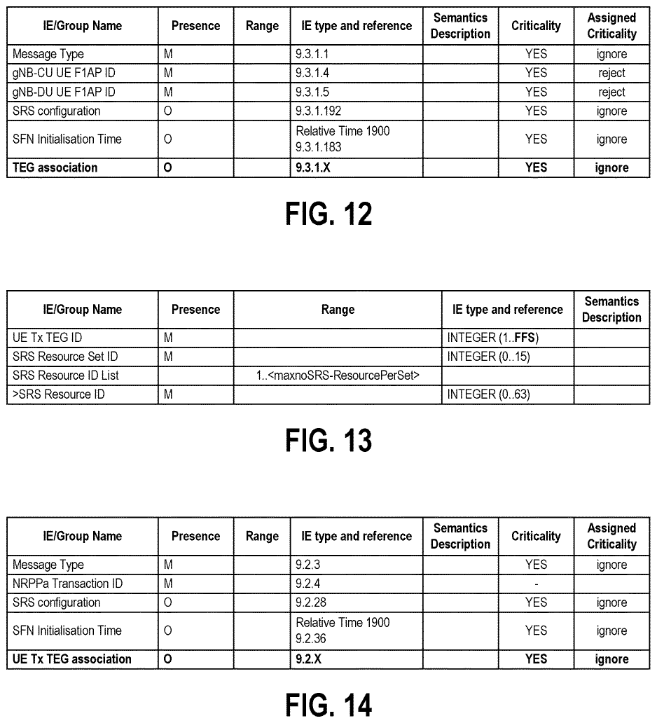

Without loss of generality, in the example illustrated in FIG. 12, the UE Tx TEG association indication is signaled using the existing F1 POSITIONING INFORMATION UPDATE message. FIG. 13 illustrates an example of the TEG Association IE.

In another embodiment, the gNB-CU can request the gNB-DU to provide the UE Tx TEG association over F1AP class 1 procedures.

Defining mechanism for serving gNB-CU to forward TEG association to LMF is described below.

In one embodiment, the serving gNB or serving gNB-CU sends the indication of the UE Tx TEG association received from the UE or serving gNB-DU to the positioning (e.g. LMF) over NRPPa. Such indication can be signaled in new Uplink UE-associated NRPPa transport message, or by re-using existing NRPPa procedures.

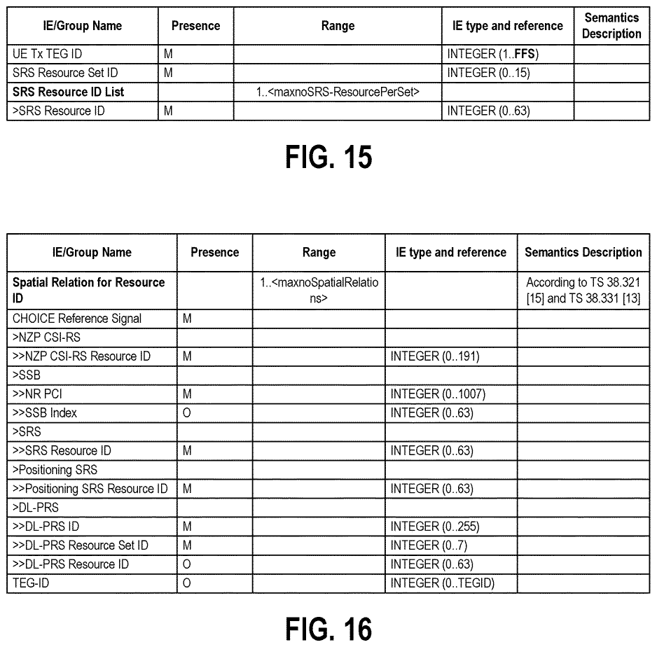

Without loss of generality, in the example illustrated in FIG. 14, the UE Tx TEG association indication is signaled using the existing NRPPa POSITIONING INFORMATION UPDATE message. This message is sent by NG-RAN node to indicate that a change in the SRS configuration has occurred. FIG. 15 illustrates an example of the TEG Association IE.

In another embodiment, the positioning server can request the serving gNB or serving gNB-CU to provide the UE Tx TEG association over class 1 NRPPa procedures.

Defining mechanism for LMF to instruct NG-RAN nodes the UL-SRS to measure is described below.

LMF receive the TEG association and utilize the info to instruct NG-RAN nodes to measure UL-SRS associated with different UE Tx TEGs. In one specific embodiment, the LMF receives the TEG association from the serving gNB, and it utilizes that information to instruct neighbour gNBs to measure UL-SRS associated with specific UE Tx TEGs.

In one embodiment, the LMF provides the UE Tx TEGs in new Downlink non-UE-associated NRPPa transport message, or by re-using existing NRPPa procedures, such as the Measurement procedure. Without loss of generality, in the examples below, the Tx TEG indication (or TEG) is carried using the existing NRPPa MEASUREMENT REQUEST message.

In one of the embodiments, the LMF informs NG-RAN node (TRP, RP) the SRS Resources which it should prioritize to measure based upon TEG information. The LMF may identify the matching RxTEG (antenna elements/panel) of the TRP (listening node) that can be used to perform the measurement (as shown in the table of FIG. 16). Alternatively, the LMF may provide to the TRP the Rx beam from a TEG of the TRP which can be associated to perform the UL SRS measurement. This may come as part of spatial relation as shown in below.

In one embodiment, the LMF initiates the procedure by sending a MEASUREMENT REQUEST message to the NG-RAN node, indicating in the TRP Measurement Request List IE the Tx TEG to use by the TRP(s) from which measurements are requested.

In one embodiment, the LMF initiates the procedure by sending a MEASUREMENT REQUEST message to the NG-RAN node, indicating in the TRP Measurement Quantities IE the Tx TEG that the NG-RAN node may take it into account when configuring measurements including e.g. UL RTOA and gNB-Rx-Tx.

In one embodiment, the LMF initiates the procedure by sending a MEASUREMENT REQUEST message to the NG-RAN node, indicating Tx TEG that the NG-RAN node may take into account to configure positioning measurements for all the indicated TRP(s).

FIG. 16 includes a table illustrating an example of an information element that indicates a spatial relation for transmission of UL SRS by a UE.

The TEG-ID can be the TRPs RxTEG-ID; thus, when UE happens to transmit UL SRS; the TRP measures the UL SRS using antenna panels/elements etc. associated (matching) with the TRP's Rx TEG-ID; if provided by the LMF. The UE Tx TEG can be coupled with TRP Rx TEG.

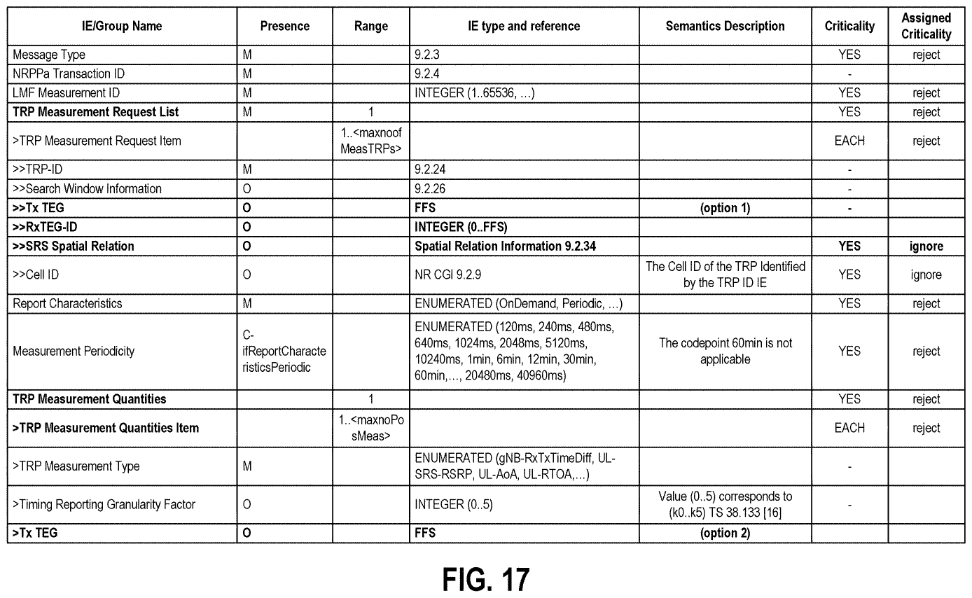

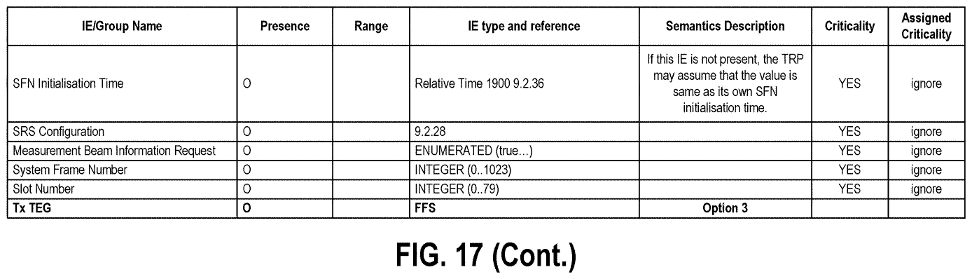

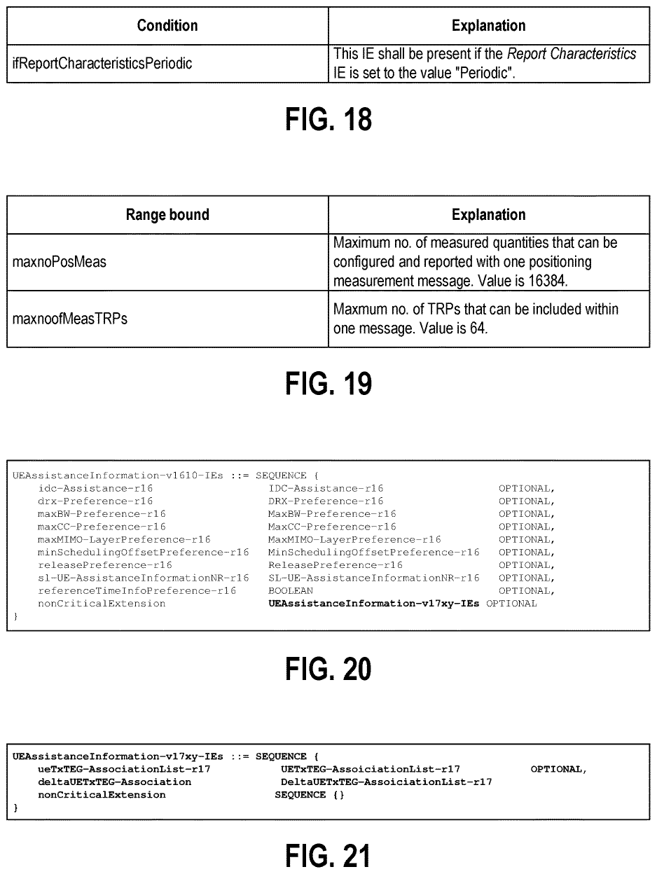

A measurement request message is sent by the LMF to request the NG-RAN node to configure a positioning measurement. FIGS. 17-19 illustrate examples of a measurement request message, conditions on when to transmit the message, and bounds on what can be included in the message. FIG. 17 illustrates an example of a measurement request message according to some embodiments, with new portions bolded. FIG. 18 includes an explanation that a “ifReportCharteristicsPeriodic” condition is present if the Report Characteristics IE is set to the value periodic. FIG. 19 includes an explanation of “maxnoPosMeas” as being the maximum number of measured quantities that can be configured and reported with one positioning measurement message. FIG. 19 further includes an explanation of “maxnoofMeasTRPs” as being the maximum number of TRPs that can be included within one message.

In one embodiment, supplementary information is signaled over F1 from gNB-CUs to their gNB-DUs on the Tx TEG association and how to utilize the indication to instruct TRPs to measure UL-SRS, UL-RTOA associated with different UE Tx TEGs

Defining IE to transmit TEG association from UE to serving gNB in RRC and MAC-CE is described below.

RRC message such as UEInformationResponse or UEAssistanceInformation can be extended to include the information of TEG association to the serving gNB. It is also possible to create a new RRC message to covey the TEG association.

FIG. 20 illustrates an example of a UEAssistanceInformation IE including the TEG association. FIG. 21 illustrates an example of a UEAssistnaceInformation IE including a delta of the TEG association.

In some embodiments, the structure is provided to show the association either using SRS Resource set or using SRS Resource(s) or combination of both. In static environment, where the propagation and radio conditions do not change much, the TEGs can be associated with SRS Resource set and UE may save signaling bits by not having to provide the association of every SRS resource within the SRS resource set with the TEG. In such case, the TEG is associated to SRS Resource set ID.

In additional or alternative embodiments, the TEG-IDs are associated to the SRS resources within one or more SRS resource sets. In some embodiments, a TEG-ID of a default value or value 0, if assigned, implies implicitly that the SRS transmission in that SRS resource does not have any association with any TEG.

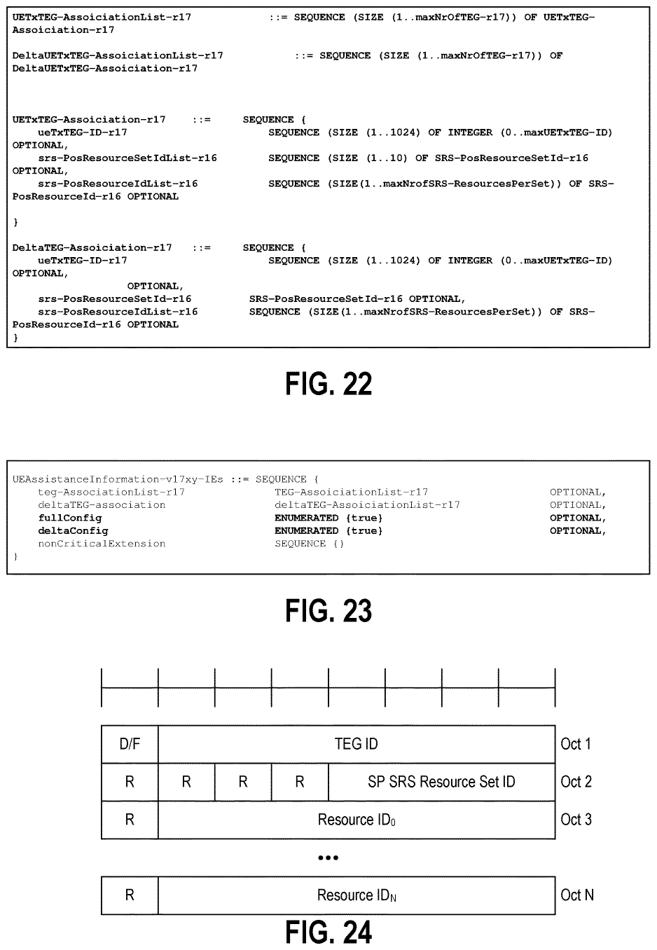

FIG. 22 illustrates an example of the ASN.1 code for UE Tx Association reporting.

FIG. 23 illustrates an example in which a tag or flag is included indicating whether the UE sends full or only delta configuration.

FIG. 24 illustrates an example of a new MAC control element and associated UL Logical channel ID can be defined where by UE may also report any delta/change or full/updated TEG configuration using MAC CE which may reduce latency when compared to RRC. This mode may be preferred for non-delay tolerant positioning applications.

The ‘D/F’ field in the MAC CE represents either delta or full configuration. The MAC CE octet may further increase depending upon the number of TEG IDs. For simplicity the structure with one TEG ID is shown.

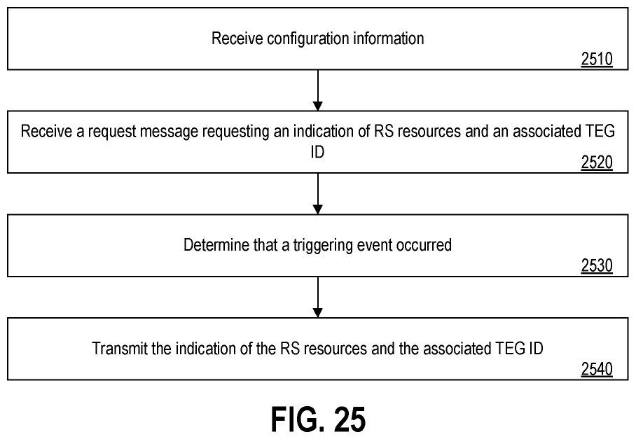

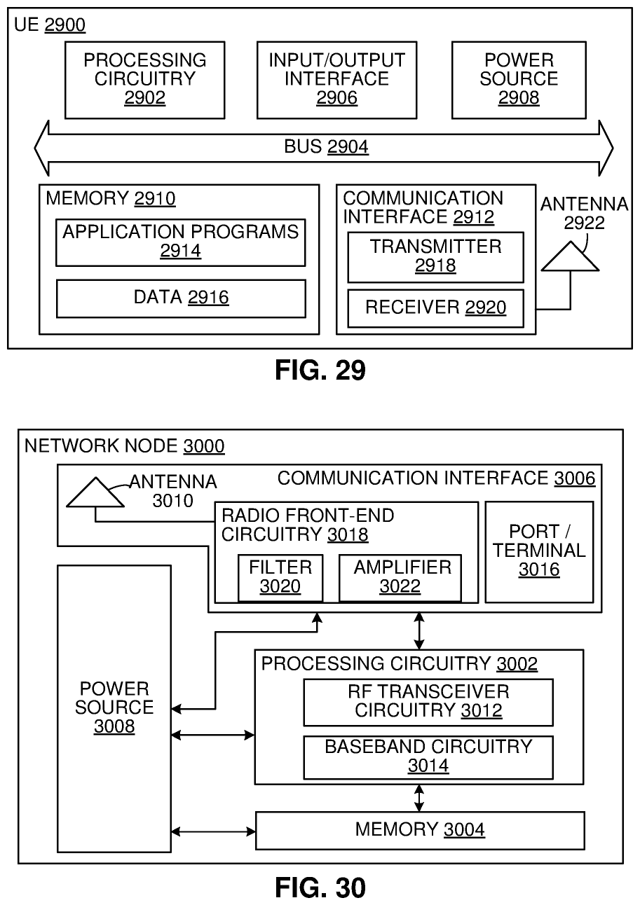

In the description that follows, while the communication device may be any of UE 2812A-D, 2900, hardware 3204, or virtual machine 3208A, 3208B, the communication device 2900 shall be used to describe the functionality of the operations of the communication device. Operations of the communication device 2900 (implemented using the structure of FIG. 29) will now be discussed with reference to the flow chart of FIG. 25 according to some embodiments of inventive concepts. For example, modules may be stored in memory 2910 of FIG. 29, and these modules may provide instructions so that when the instructions of a module are executed by respective communication device processing circuitry 2902, processing circuitry 2902 performs respective operations of the flow chart.

FIG. 25 illustrates an example of operations performed by a communication device of a communications network.

At block 2510, processing circuitry 2902 receives, via communication interface 2912, configuration information. In some embodiments, the configuration information includes an indication of a reporting type to use to transmit the indication of the RS resource and/or the indication of the TEG ID to the network node. In additional or alternative embodiments, the reporting type includes at least one of a RRC reporting type; and a MAC CE reporting type.

At block 2520, processing circuitry 2902 receives, via communication interface 2912, a request message requesting an indication of RS resources and an associated TEG ID. In some embodiments, the indication of the RS resources comprises an indication of a delta between a measurement of the RS resources and a measurement of previous RS resources.

At block 2530, processing circuitry 2902 determines that a triggering event occurred. In some embodiments, determining that the triggering event has occurred includes determining that a change in the RS resources relative to previously measured RS resource measurements exceeds a threshold value.

At block 2540, processing circuitry 2902 transmits, via communication interface 2912, the indication of the RS resources and the associated TEG ID. In some embodiments, transmitting the indication of the RS resource and the indication of the TEG ID includes transmitting at least one of the indication of the RS resource and the indication of the TEG ID at a predetermined periodicity.

In additional or alternative embodiments, transmitting the indication of the RS resource and the indication of the TEG ID includes transmitting at least one of the indication of the RS resource and the indication of the TEG ID in response to determining that the triggering event has occurred.

In additional or alternative embodiments, transmitting the indication of the RS resources includes transmitting an expanded RRC message that includes at least one of a UEInformationResponse message and a UEAssistanceInformation message.

In additional or alternative embodiments, the RS resources includes SRS resources.

Various operations of FIG. 25 may be optional with respect to some embodiments. For example, in regards to some embodiments, blocks 2510 and 2530, and may be optional.

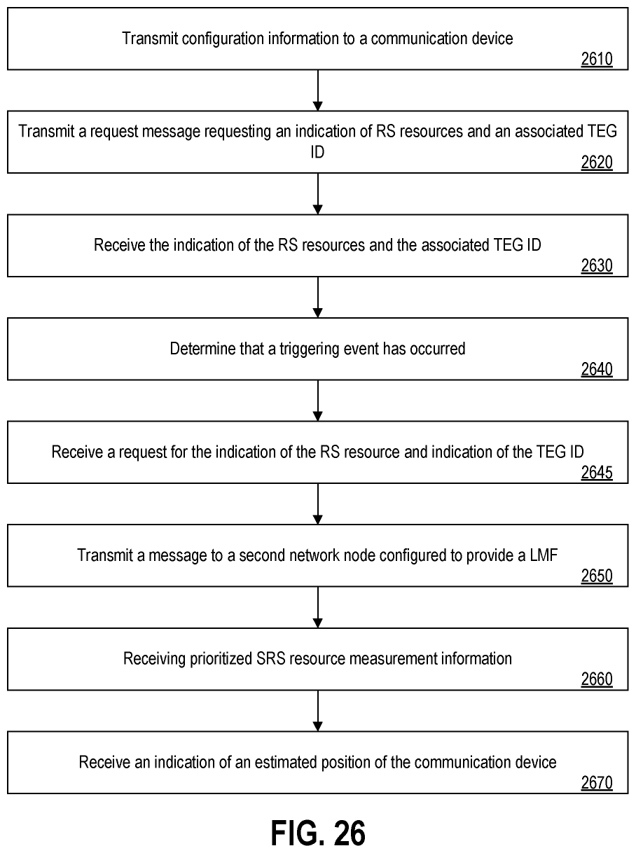

In the description that follows, while the network nodes may be any of the network node 2810A, 2810B, 3000, 3306, hardware 3204, or virtual machine 3208A, 3208B, the network node 3000 shall be used to describe the functionality of the operations of the network nodes. Operations of the network node 3000 (implemented using the structure of FIG. 30) will now be discussed with reference to the flow charts of FIG. 26 according to some embodiments of inventive concepts. For example, modules may be stored in memory 3004 of FIG. 30, and these modules may provide instructions so that when the instructions of a module are executed by respective network node processing circuitry 3002, processing circuitry 3002 performs respective operations of the flow charts.

FIG. 26 illustrates an example of operations performed by a network node of a communications network.

At block 2610, processing circuitry 3002 transmits, via communication interface 3006, configuration information to a communication device. In some embodiments, the configuration information includes an indication of a reporting type for the communication device to use to transmit the indication of the RS resource and/or the indication of the TEG ID to the network node. In additional or alternative embodiments, the reporting type includes at least one of a RRC reporting type and a MAC CE reporting type.

At block 2620, processing circuitry 3002 transmits, via communication interface 3006, a request message requesting an indication of a RS resource and an associated TEG ID.

At block 2630, processing circuitry 3002 receives, via communication interface 3006, the indication of the RS resources and the associated TEG ID. In some embodiments, receiving the indication of the RS resources includes receiving an expanded RRC message that includes at least one of a UEInformationResponse message and a UEAssistanceInformation message.

At block 2640, processing circuitry 3002 determines that a triggering event has occurred. In some embodiments, determining that the triggering event has occurred includes determining that a change in the RS resources relative to previously measured RS resources exceeds a threshold value.

At block 2645, processing circuitry 3002 receives, via communication interface 3006, a message including a request for the indication of the RS resources and indication of the TEG ID.

At block 2650, processing circuitry 3002 transmits, via communication interface 3006, a message to a second network node configured to provide a LMF. In some embodiments, transmitting the message to the second network node includes transmitting the message to the second network node in response to determining that the triggering event has occurred.

In additional or alternative embodiments, the TEG ID is a first TEG ID associated with an antenna of the communication device and the message to the second network node further includes a second TEG ID associated with an antenna of the first network node. In some examples, the first TEG ID is a TX TEG ID and the second TEG ID is a RX TEG ID.

At block 2660, processing circuitry 3002 receives, via communication interface 3006, prioritized SRS resource measurement information.

At block 2670, processing circuitry 3002 receives, via communication interface 3006, an indication of an estimated position of the communication device.

In some embodiments, the RS resources include SRS resources.

Various operations of FIG. 26 may be optional with respect to some embodiments. For example, in regards to some embodiments, blocks 2610, 2640, 2650, 2660, and 2670 may be optional.

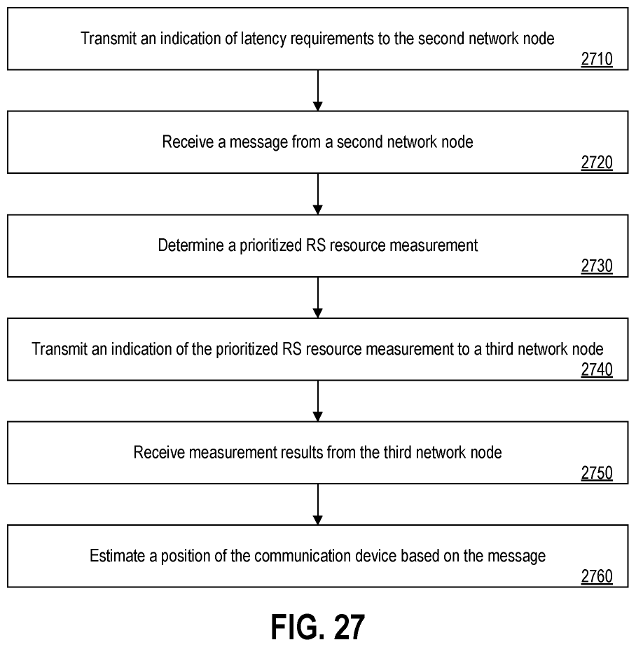

In the description that follows, while the network nodes may be any of the network node 2808, 3000, 3306, hardware 3204, or virtual machine 3208A, 3208B, the network node 3000 shall be used to describe the functionality of the operations of the network nodes. Operations of the network node 3000 (implemented using the structure of FIG. 30) will now be discussed with reference to the flow charts of FIG. 27 according to some embodiments of inventive concepts. For example, modules may be stored in memory 3004 of FIG. 30, and these modules may provide instructions so that when the instructions of a module are executed by respective network node processing circuitry 3002, processing circuitry 3002 performs respective operations of the flow charts.

FIG. 27 illustrates an example of operations performed by a first network node of a communications network, the first network node being configured to provide a LMF.

At block 2710, processing circuitry 3002 transmits, via communication interface 3006, an indication of latency requirements to the second network node.

At block 2720, processing circuitry 3002 receives, via communication interface 3006, a message from a second network node. In some embodiments, the message includes: an indication of RS resources used for communication between the second network node and a communication device; an indication of a first TEG ID associated with the RS resources and the communication device; and an indication of second TEG ID associated with the RS resources and the second network node.

At block 2730, processing circuitry 3002 determines a prioritized RS resource measurement.

At block 2740, processing circuitry 3002 transmits, via communication interface 3006, an indication of the prioritized RS resource measurement to a third network node.

At block 2750, processing circuitry 3002 receives, via communication interface 3006, measurement results from the third network node.

At block 2760, processing circuitry 3002 estimates a position of the communication device based on the message. In some embodiments, estimating the position of the communication device includes estimating the position of the communication device based on the measurement results.

In some embodiments, the RS resources include SRS resources.

Various operations of FIG. 27 may be optional with respect to some embodiments. For example, in regards to some embodiments, blocks 2710, 2730, 2640, and 2650 may be optional.

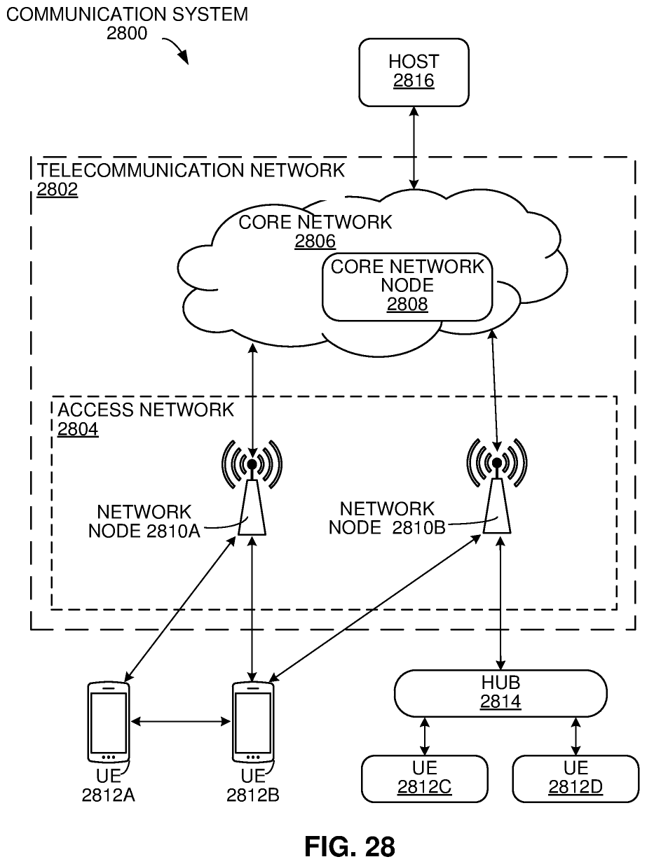

FIG. 28 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 28 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub-that is, a hub whose primary function is to route communications to/from the UEs from/to the network node 2810b. In other embodiments, the hub 2814 may be a non-dedicated hub-that is, a device which is capable of operating to route communications between the UEs and network node 2810b, but which is additionally capable of operating as a communication start and/or end point for certain data channels.

FIG. 29 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 29. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 29.

As yet another specific example, in an IoT scenario, a UE may represent a machine or other device that performs monitoring and/or measurements, and transmits the results of such monitoring and/or measurements to another UE and/or a network node. The UE may in this case be an M 2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 30 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010.

Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment.

Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 30 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

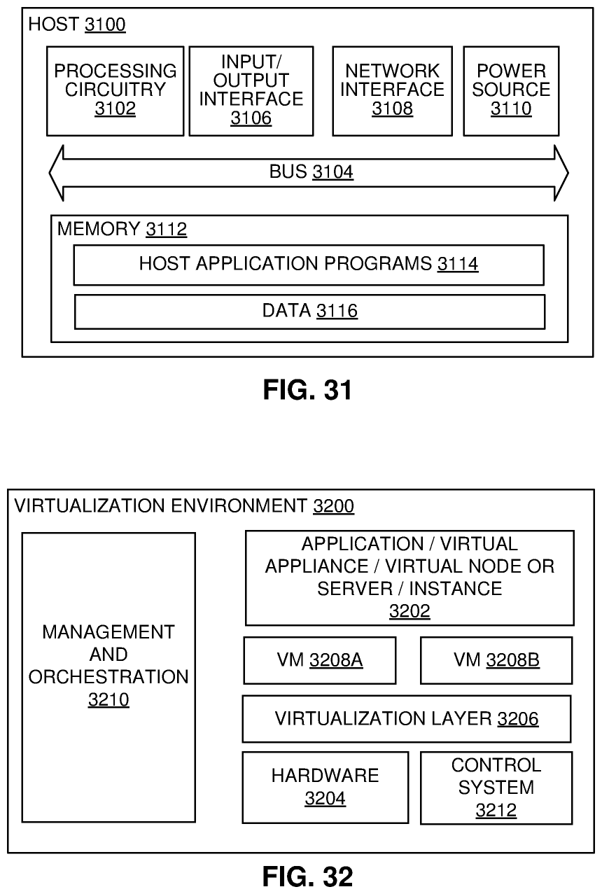

FIG. 31 is a block diagram of a host 3100, which may be an embodiment of the host 2816 of FIG. 28, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 29 and 30, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 32 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

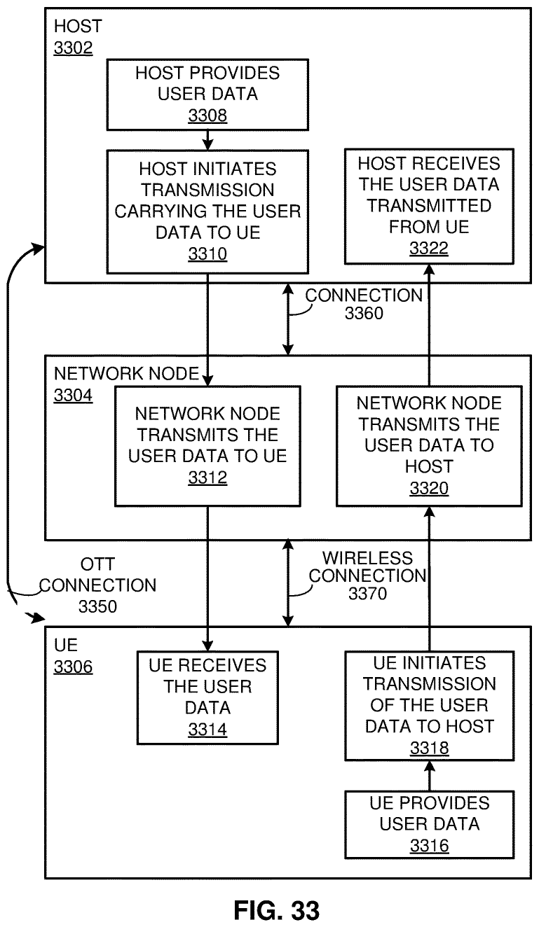

FIG. 33 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 28 and/or UE 2900 of FIG. 29), network node (such as network node 2810a of FIG. 28 and/or network node 3000 of FIG. 30), and host (such as host 2816 of FIG. 28 and/or host 3100 of FIG. 31) discussed in the preceding paragraphs will now be described with reference to FIG. 33.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 28) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may allow a multinode cloud-based system (e.g., a FaaS system) to schedule functions based on requirements of the function and a status of the cloud-based system, and thereby ensure E2E RT runtimes for RT functions.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc. ; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-32. (canceled)

33. A method of operating a communication device of a communications network, the method comprising:
receiving a request message from a network node of the communications network, the request message requesting an indication of reference signal, RS, resources used by the communication device to communicate with the network node and an indication of a timing error group, TEG, identifier, ID, associated with the RS resources;
transmitting the indication of the RS resources and the indication of the TEG ID to the network node; and
receiving configuration information from the network node,
wherein the configuration information comprises an indication of a reporting type to use to transmit the indication of the RS resource and/or the indication of the TEG ID to the network node.

34. The method of claim 33, wherein transmitting the indication of the RS resource and the indication of the TEG ID comprises transmitting at least one of the indication of the RS resource and the indication of the TEG ID at a predetermined periodicity.

35. The method of claim 33, further comprising:
determining that a triggering event has occurred,
wherein transmitting the indication of the RS resource and the indication of the TEG ID comprises transmitting at least one of the indication of the RS resource and the indication of the TEG ID in response to determining that the triggering event has occurred.

36. The method of claim 35, wherein determining that the triggering event has occurred comprises determining that a change in the RS resources relative to previously measured RS resource measurements exceeds a threshold value.

37. The method of claim 33, wherein the indication of the RS resources comprises an indication of a delta between a measurement of the RS resources and a measurement of previous RS resources.

38. The method of claim 33,
wherein the reporting type comprises at least one of a radio resource control, RRC, reporting type; and a media access control, MAC, control element, CE, reporting type.

39. The method of claim 38, wherein the reporting type comprises the RRC reporting type, and
wherein transmitting the indication of the RS resources comprises transmitting an expanded RRC message comprising at least one of a UEInformationResponse message; and a UEAssistanceInformation message.

40. A method of operating a first network node of a communications network, the method further comprising:
determining a timing error group, TEG, identifier, ID, associated with reference signal, RS, resources used by a communication device to communicate with the first network node; and
transmitting a message to a second network node configured to provide a location management function, LMF, the message comprising the indication of the RS resources and the indication of the TEG ID.

41. The method of claim 40, wherein the message comprises a second message, the method further comprising:
receiving a first message from the second network node, the first message including a request for the indication of the RS resources and indication of the TEG ID.

42. The method of claim 41, wherein transmitting the second message comprises transmitting the second message in response to receiving the first message.

43. The method of claim 41 wherein the first message further includes a request to periodically transmit positioning information associated with the communication device, and wherein transmitting the second message comprises periodically transmitting the second message based on the request to periodically transmit.

44. The method of claim 40, further comprising:
determining that a triggering event has occurred,
wherein transmitting the message to the second network node comprises transmitting the message to the second network node in response to determining that the triggering event has occurred, and
wherein determining that the triggering event has occurred comprises determining that a change in the RS resources relative to previously measured RS resources exceeds a threshold value.

45. The method of claim 40, wherein transmitting the message comprises transmitting the message via a New Radio Positioning Protocol A, NRPPa, interface.

46. The method of claim 40, wherein the TEG ID comprises a first TEG ID associated with an antenna of the communication device, and
wherein the message to the second network node further comprises a second TEG ID associated with an antenna of the first network node.

47. The method of claim 46, wherein the first TEG ID comprises a transmission, TX, TEG ID, and
wherein the second TEG ID comprises a reception, RX, TEG ID.

48. The method of claim 40, further comprising:
responsive to transmitting the message to the second network node, receiving prioritized SRS resource measurement information from the second network node.

49. A method of operating a first network node of a communications network, the first network node configured to provide a location management function, LMF, the method comprising:
receiving a message from a second network node, the message comprising:
an indication of reference signal, RS, resources used for communication between the second network node and a communication device;
an indication of a first timing error group, TEG, identifier, ID, associated with the RS resources and the communication device; and
an indication of second TEG ID associated with the RS resources and the second network node; and
estimating a position of the communication device based on the message.

50. The method of claim 49, further comprising:
determining a prioritized RS resource measurement;
transmitting an indication of the prioritized RS resource measurement to a third network node communicatively coupled to the communication device; and
receiving measurement results from the third network node, wherein estimating the position of the communication device comprises estimating the position of the communication device based on the measurement results.

51. A communication device operating in a communications network, the communication device comprising:
processing circuitry;
memory coupled with the processing circuitry, wherein the memory includes instructions that when executed by the processing circuitry causes the communication device to perform operations comprising:
receive a request message from a network node of the communications network, the request message requesting an indication of reference signal, RS, resources used by the communication device to communicate with the network node and an indication of a timing error group, TEG, identifier, ID, associated with the RS resources;
transmit the indication of the RS resources and the indication of the TEG ID to the network node; and
receive configuration information from the network node,
wherein the configuration information comprises an indication of a reporting type to use to transmit the indication of the RS resource and/or the indication of the TEG ID to the network node.

52. The communication device of claim 51, wherein transmit the indication of the RS resource and the indication of the TEG ID comprises transmit at least one of the indication of the RS resource and the indication of the TEG ID at a predetermined periodicity.

53. The communication device of claim 51, wherein the memory includes instructions that when executed by the processing circuitry causes the communication device to perform further operations comprising:
determine that a triggering event has occurred,
wherein transmit the indication of the RS resource and the indication of the TEG ID comprises transmitting at least one of the indication of the RS resource and the indication of the TEG ID in response to determining that the triggering event has occurred.

54. The communication device of claim 53, wherein determine that the triggering event has occurred comprises determine that a change in the RS resources relative to previously measured RS resource measurements exceeds a threshold value.

55. A network node operating in a communications network, the network node comprising:
processing circuitry;
memory coupled with the processing circuitry, wherein the memory includes instructions that when executed by the processing circuitry causes the network node to perform operations comprising:
determine a timing error group, TEG, identifier, ID, associated with reference signal, RS, resources used by a communication device to communicate with the first network node; and
transmit a message to a second network node configured to provide a location management function, LMF, the message comprising the indication of the RS resources and the indication of the TEG ID.

56. The network node of claim 55, wherein the message comprises a second message, the operations further comprising:
receive a first message from the second network node, the first message including a request for the indication of the RS resources and indication of the TEG ID.

57. The network node of claim 56, wherein transmit the second message comprises transmit the second message in response to receiving the first message.

57. The network node of claim 56, wherein the first message further includes a request to periodically transmit positioning information associated with the communication device, and
wherein transmit the second message comprises periodically transmit the second message based on the request to periodically transmit.
